(19) United States
(12) Patent Application Publication
(10) Pub. No.: US 2025/0214111 A1
(43) Pub. Date: Jul. 3, 2025

(54) ROTOR AND ULTRASONIC MOTOR

(71) Applicant: Murata Manufacturing Co., Ltd., Nagaokakyo-shi (JP)

(72) Inventor: Hiroshi ASANO, Nagaokakyo-shi (JP)

(21) Appl. No.: 19/083,516

(22) Filed: Mar. 19, 2025

Related U.S. Application Data
(63) Continuation of application No. PCT/JP2023/025919, filed on Jul. 13, 2023.

(30) Foreign Application Priority Data
Nov. 18, 2022 (JP) 2022-184747

(51) Int. Cl. B06B 1/06

(52) U.S. Cl. CPC B06B 1/0651

(57) ABSTRACT

A rotor used for an ultrasonic motor, the rotor including a rotor main body; and a plurality of friction materials in the rotor main body and arranged for contact with a vibrating body of a stator, wherein the plurality of friction materials include resin, and wherein the plurality of friction materials are dispersedly arranged in an annular track in a plan view of the rotor.

### CROSS REFERENCE TO RELATED APPLICATIONS

The present application is a continuation of International application No. PCT/JP2023/025919, filed Jul. 13, 2023, which claims priority to Japanese Patent Application No. 2022-184747, filed Nov. 18, 2022, the entire contents of each of which are incorporated herein by reference.

### TECHNICAL FIELD

The present description relates to a rotor used for an ultrasonic motor, and an ultrasonic motor using the rotor.

### BACKGROUND ART

Conventionally, there have been proposed various ultrasonic motors in each of which a stator is vibrated by a piezoelectric element. Patent Document 1 below discloses one example of an ultrasonic motor. In this ultrasonic motor, the rotor is rotated by a progressive vibration wave generated in a stator.

The stator described in Patent Document 1 includes a ring-shaped elastic body and a ring-shaped piezoelectric body. Examples of the material of the elastic body include phosphor bronze, stainless steel, and invar. The elastic body has a plurality of protrusions arranged in an annular shape. On the other hand, the rotor has a ring-shaped rotor base material and a ring-shaped slider material. The slider material is bonded to the rotor base material. The slider material in the rotor is in contact with the plurality of protrusions in the elastic body of the stator.

Patent Document 1: Japanese Patent Application Laid-Open No. H3-74182

### SUMMARY OF THE DESCRIPTION

In the ultrasonic motor described in Patent Document 1, foreign matter generated by wear of a stator or the like during driving can be suitably discharged from between the plurality of protrusions. However, when the plurality of protrusions is formed on the elastic body, it is necessary to cut the elastic body. Therefore, it is difficult to sufficiently enhance productivity.

An object of the present description is to provide a rotor capable of enhancing productivity of an ultrasonic motor and an ultrasonic motor using the rotor.

A rotor according to the present description is a rotor used in an ultrasonic motor and includes: a rotor main body; and a plurality of friction materials in the rotor main body and arranged for contact with a vibrating body of a stator, in which the plurality of friction materials include resin, and in which the plurality of friction materials are dispersedly arranged in an annular track in a plan view of the rotor.

An ultrasonic motor according to the present description includes: a rotor configured according to the present description; and a stator including the vibrating body and a vibration generating element on the vibrating body, in which the vibrating body includes a contact surface in contact with the plurality of friction materials, and in which the contact surface has a planar shape.

According to the present description, it is possible to provide a rotor capable of enhancing productivity of an ultrasonic motor and an ultrasonic motor using the rotor.

### BRIEF EXPLANATION OF THE DRAWINGS

FIG. 1 is a schematic front sectional view of an ultrasonic motor according to a first embodiment of the present description.

FIG. 2 is a schematic perspective view of a rotor according to the first embodiment of the present description.

FIG. 3 is a schematic perspective view illustrating a part of FIG. 2 in an enlarged manner.

FIG. 4 is a schematic sectional view taken along line I-I in FIG. 3.

FIG. 5 is a schematic sectional view along an annular track showing the vicinity of a portion where one friction material is provided in a leaf spring portion of the rotor in the first embodiment of the present description.

FIG. 6 is a schematic plan view illustrating the vicinity of a portion where one friction material is provided on a first surface of the leaf spring portion of the rotor in the first embodiment of the present description.

FIG. 7 is a schematic plan view illustrating the vicinity of a portion where one friction material is provided on the first surface of the leaf spring portion of the rotor for explaining a shape of a through hole according to the first embodiment of the present description.

FIG. 8 is a front sectional view of a piezoelectric element according to the first embodiment of the present description.

FIG. 9 is a schematic plan view illustrating the vicinity of a portion where one friction material is provided on the first surface of the leaf spring portion of the rotor in a modification of the first embodiment of the present description.

FIG. 10 is a schematic plan view illustrating the vicinity of a portion where one friction material is provided on the first surface of the leaf spring portion of the rotor in a second embodiment of the present description.

FIG. 11 is a schematic sectional view along an annular track showing the vicinity of a portion where one friction material is provided in the leaf spring portion of the rotor in the second embodiment of the present description.

FIG. 12 is a schematic plan view illustrating the vicinity of a portion where one friction material is provided on the first surface of the leaf spring portion of the rotor in a modification of the second embodiment of the present description.

FIG. 13 is a schematic plan view illustrating the vicinity of a portion where one friction material is provided on the first surface of the leaf spring portion of the rotor in a third embodiment of the present description.

FIG. 14 is a schematic plan view illustrating the vicinity of a portion where one friction material is provided on the first surface of the leaf spring portion of the rotor in a modification of the third embodiment of the present description.

### DESCRIPTION OF THE PREFERRED EMBODIMENTS

Hereinafter, the present description will be clarified by describing specific embodiments with reference to the drawings.

Note that each of the embodiments described in the present description is an embodiment, and replacement of some part or combination of configurations is possible among different embodiments.

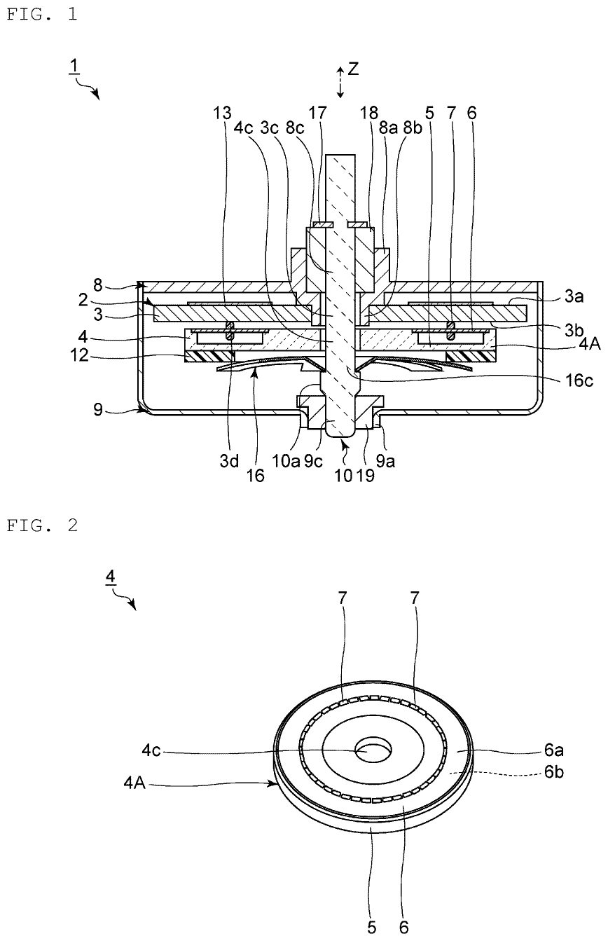

FIG. 1 is a schematic front sectional view of an ultrasonic motor according to a first embodiment of the present description.

The ultrasonic motor 1 includes a stator 2, a rotor 4, and a shaft member 10. The stator 2 and the rotor 4 are in contact with each other. The rotor 4 is a rotor according to an embodiment of the present description. The rotor 4 is rotated by a traveling wave generated in the stator 2. As the rotor 4 rotates, the shaft member 10 rotates. The rotation center axis of the ultrasonic motor 1 is located at a portion where the shaft member 10 is provided. Hereinafter, a specific configuration of the ultrasonic motor 1 will be described.

The stator 2 includes a plate-shaped vibrating body 3. The vibrating body 3 has a disk shape. The vibrating body 3 has a first main surface 3a and a second main surface 3b. The first main surface 3a and the second main surface 3b face each other. In the present specification, the axial direction Z is a direction connecting the first main surface 3a and the second main surface 3b, and is a direction along the rotation center axis. In the present embodiment, the axial direction Z is parallel to the direction in which the shaft member 10 extends.

A through hole 3c is provided in a central portion of the vibrating body 3. The shaft member 10 is inserted through the through hole 3c. The position of the through hole 3c is not limited to the central portion of the vibrating body 3. The through hole 3c may be located in a region including the rotation center axis. Further, the shape of the vibrating body 3 is not limited to a disk shape. The shape of the vibrating body 3 viewed from the axial direction Z may be a regular polygon such as a regular hexagon, a regular octagon, or a regular decagon. In the present specification, a polygon includes a case where a portion corresponding to a vertex has a curved shape and a case where the portion has a chamfered shape. Hereinafter, viewing from the axial direction Z may be referred to as plan view.

The vibrating body 3 includes an appropriate metal. However, the vibrating body 3 is not necessarily includes metal. The vibrating body 3 may be configured with another elastic body such as ceramics, a silicon material, or a synthetic resin.

A plurality of piezoelectric elements 13 are provided on the first main surface 3a of the vibrating body 3. The piezoelectric elements 13 are a vibration generating element in the present description. In a plan view, the plurality of piezoelectric elements 13 are dispersedly arranged in the circumferential direction. More specifically, the plurality of piezoelectric elements 13 are dispersedly arranged along a circumferential direction of a traveling wave so as to generate the traveling wave that circles around an axis parallel to the axial direction Z as a center. In the stator 2, a structure in which the plurality of piezoelectric elements 13 are dispersedly arranged in the circumferential direction and driven to generate a traveling wave is disclosed in, for example, WO 2010/061508 A. Therefore, a detailed description of the generation of the traveling wave will be omitted.

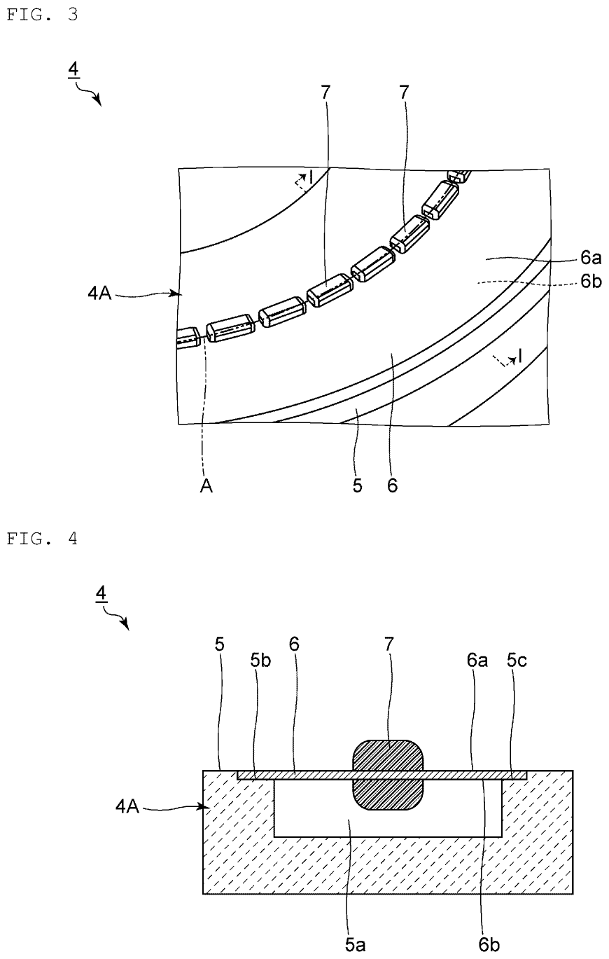

FIG. 2 is a schematic perspective view of the rotor according to the first embodiment. FIG. 3 is a schematic perspective view illustrating a part of FIG. 2 in an enlarged manner.

As illustrated in FIG. 2, the rotor 4 includes a rotor main body 4A and a plurality of friction materials 7. The rotor main body 4A has a disk shape. A through hole 4c is provided in a central portion of the rotor main body 4A. The shaft member 10 illustrated in FIG. 1 is inserted into the through hole 4c. However, the position of the through hole 4c is not limited to the central portion of the rotor main body 4A. The through hole 4c may be located in a region including the axial direction center. Further, the shape of the rotor main body 4A is not limited to the above. The shape of the rotor main body 4A may be, for example, a regular polygon such as a regular hexagon, a regular octagon, or a regular decagon in plan view.

The rotor main body 4A includes a rotor base portion 5 and a leaf spring portion 6. The outer shape of the rotor main body 4A in plan view is the outer shape of the rotor base portion 5 in plan view. The through hole 4c of the rotor main body 4A is provided in the rotor base portion 5. On the other hand, the leaf spring portion 6 has a ring shape in the plan view. The leaf spring portion 6 is provided so as to surround the through hole 4c. As a material of the rotor base portion 5, an appropriate metal, an appropriate ceramic, or the like can be used. As a material of the leaf spring portion 6, an appropriate metal or the like can be used.

The plurality of friction materials 7 are provided on the rotor main body 4A. Specifically, the plurality of friction materials 7 are provided on the leaf spring portion 6 of the rotor main body 4A. As illustrated in FIGS. 2 and 3, the plurality of friction materials 7 are dispersedly arranged along the circumferential direction of the traveling wave. Therefore, the plurality of friction materials 7 are dispersedly arranged on the annular track in the plan view. In FIG. 3, an annular track A is indicated by a two-dot chain line. In the present embodiment, the annular track A is an annular track. Hereinafter, when described as an annular track, unless otherwise specified, the annular track refers to an annular track in which a plurality of friction materials 7 are dispersed.

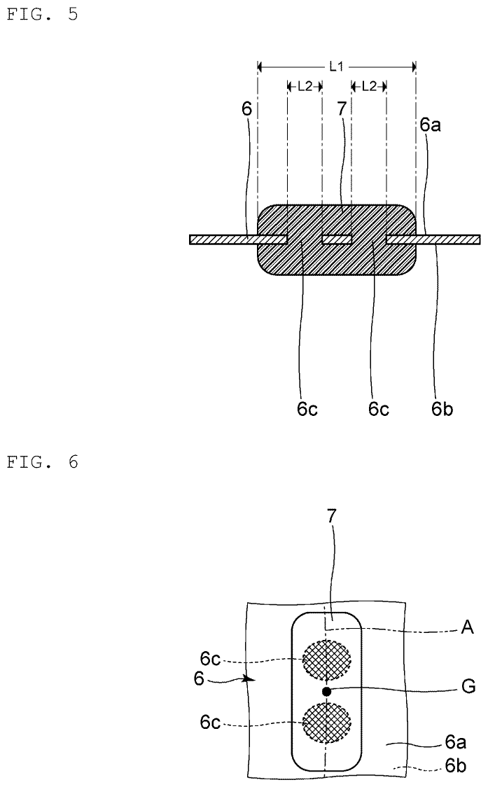

FIG. 4 is a schematic sectional view taken along line I-I in FIG. 3. FIG. 5 is a schematic sectional view along an annular track showing the vicinity of a portion where one friction material is provided in the leaf spring portion of the rotor in the first embodiment. The portion along the annular track is a curved portion, but in FIG. 5, the portion is schematically shown as a flat surface.

As illustrated in FIG. 4, the rotor base portion 5 has a recessed portion 5a. Although not illustrated, the shape of the recessed portion 5a in the plan view is a ring shape. The leaf spring portion 6 is provided on the rotor base portion 5 so as to cover the recessed portion 5a. The leaf spring portion 6 has a first surface 6a and a second surface 6b. The first surface 6a and the second surface 6b face opposite to each other. Among the first surface 6a and the second surface 6b, the first surface 6a is located on the stator 2 side illustrated in FIG. 1.

As illustrated in FIG. 5, the leaf spring portion 6 is provided with a plurality of through holes 6c extending from the first surface 6a to the second surface 6b. Each friction material 7 is provided over the first surface 6a, the insides of the through holes 6c, and the second surface 6b of the leaf spring portion 6. Specifically, each friction material 7 is provided over the first surface 6a, the insides of the two through holes 6c, and the second surface 6b.

The plurality of friction materials 7 include an appropriate resin. The leaf spring portion 6 and the plurality of friction materials 7 of the present embodiment are an insert molded body integrally formed. That is, the plurality of friction materials 7 are provided in the leaf spring portion 6 by performing insert molding using the leaf spring portion 6 having the plurality of through holes 6c.

Each friction material 7 may be provided in the first surface 6a, the insides of the three or more through holes 6c, and the second surface 6b. Alternatively, each friction material 7 may be provided over the first surface 6a, the inside of only one through hole 6c, and the second surface 6b.

FIG. 6 is a schematic plan view illustrating the vicinity of a portion where one friction material is provided on the first surface of the leaf spring portion of the rotor in the first embodiment. In FIG. 6, the through holes 6c are hatched.

The shape of the friction material 7 in plan view is rectangular. Note that a portion corresponding to each vertex of the rectangle is curved. On the other hand, the through hole 6c of the leaf spring portion 6 has an elliptical shape in plan view. However, the shapes of the friction material 7 and the through hole 6c in plan view are not limited to the above.

Returning to FIG. 2, the feature of the present embodiment is that the plurality of friction materials 7 in the rotor 4 are dispersedly arranged in an annular track in plan view. As a result, at the time of driving the ultrasonic motor 1 illustrated in FIG. 1, foreign matter generated by wear of the stator 2 and the rotor 4 can be suitably removed from between the plurality of friction materials 7. Therefore, a concavo-convex structure in the vibrating body 3 of the stator 2, which is conventionally provided to facilitate removal of foreign substances, is not required. For this reason, in obtaining the stator 2, it is not necessary to cut the vibrating body 3 to form the uneven structure of the vibrating body 3. Therefore, complicated steps can be omitted. Therefore, productivity of the ultrasonic motor 1 can be enhanced.

Further, as shown in FIG. 1, since the plurality of friction materials 7 of the rotor 4 come into contact with the vibrating body 3 of the stator 2, frictional force applied between the vibrating body 3 and the rotor 4 can be stabilized. Accordingly, the rotor 4 can be efficiently rotated.

Hereinafter, a preferred configuration of the present embodiment will be described.

As shown in FIG. 4, it is preferable that the rotor base portion 5 has a recessed portion 5a, and the leaf spring portion 6 is provided on the rotor base portion 5 so as to cover the recessed portion 5a. It is preferable that a plurality of friction materials 7 are provided on the leaf spring portion 6. In this case, in the configuration illustrated in FIG. 1 in which the plurality of friction materials 7 are in contact with the vibrating body 3 of the stator 2, the leaf spring portion 6 is actually elastically deformed. As a result, the plurality of friction materials 7 can be more reliably and uniformly brought into contact with the vibrating body 3. Therefore, the rotor 4 can be efficiently rotated.

In addition, since the plurality of friction materials 7 are pressed against the vibrating body 3 by the elastic force of the leaf spring portion 6, the frictional force between the stator 2 and the rotor 4 can be increased. Thus, the traveling wave can be effectively propagated from the stator 2 to the rotor 4, and the rotor 4 can be efficiently rotated. Therefore, the ultrasonic motor 1 can be efficiently rotationally driven.

As illustrated in FIG. 4, the rotor base portion 5 is provided with a groove portion 5b so as to be connected to the inner peripheral edge of the recessed portion 5a. Similarly, the rotor base portion 5 is provided with a groove portion 5c so as to be connected to the outer peripheral edge of the recessed portion 5a. The groove portion 5b and the groove portion 5c each have a ring shape in plan view. The leaf spring portion 6 is provided from the groove portion 5b to the groove portion 5c. More specifically, the inner peripheral edge of the leaf spring portion 6 is located in the groove portion 5b. An outer peripheral edge of the leaf spring portion 6 is located in the groove portion 5c.

In this case, in a state where the thickness of the leaf spring portion 6 is set to a desired thickness, the thickness of the portion where the leaf spring portion 6 protrudes from the rotor base portion 5 in the axial direction Z can be reduced. Alternatively, when the dimension corresponding to the depth of the groove portion 5b and the groove portion 5c is equal to or larger than the dimension corresponding to the thickness of the leaf spring portion 6, the leaf spring portion 6 may not protrude from the rotor base portion 5 in the axial direction Z. As a result, the leaf spring portion 6 is hardly peeled off from the rotor base portion 5.

Furthermore, since the thickness of the leaf spring portion 6 is a desired thickness, the spring constant of the leaf spring portion 6 can be easily set to a sufficient value. As a result, the friction material 7 can be suitably pressed against the stator 2 illustrated in FIG. 1. Therefore, frictional force between the stator 2 and the rotor 4 can be increased. Therefore, the ultrasonic motor 1 can be efficiently rotationally driven. Note that the groove portion 5b and the groove portion 5c are not necessarily provided.

In the present embodiment, the rotor base portion 5 having the groove portion 5b and the groove portion 5c and the leaf spring portion 6 are fitted to each other. In this case, it is easy to position the leaf spring portion 6 when forming the rotor 4. Therefore, the rotor 4 can be efficiently obtained, and the productivity of the ultrasonic motor 1 can be effectively enhanced.

As illustrated in FIG. 5, each friction material 7 is preferably provided over the first surface 6a, the insides of the through holes 6c, and the second surface 6b of the leaf spring portion 6. Accordingly, the friction material 7 can be effectively fixed to the rotor main body 4A. For example, unlike a case where the friction material 7 is bonded by an adhesive, peeling of the friction material 7 can be effectively suppressed. Therefore, damage to the ultrasonic motor 1 can be effectively suppressed.

Each friction material 7 is preferably provided over the first surface 6a, the insides of the plurality of through holes 6c, and the second surface 6b of the leaf spring portion 6. In this case, it is easy to make the spring constant of the leaf spring portion 6 constant in the portion where each friction material 7 is provided. In addition, the rotation of each friction material 7 can be suppressed. In the present embodiment, the plurality of through holes 6c are arranged along the annular track A. However, the plurality of through holes 6c may be arranged along the normal line of the annular track A.

It is preferable that the leaf spring portion 6 and the plurality of friction materials 7 are integrally formed into an insert molded body. In this case, the configuration in which each friction material 7 is provided over the first surface 6a, the insides of the through holes 6c, and the second surface 6b of the leaf spring portion 6 can be easily obtained by performing insert molding. Therefore, productivity can be effectively improved.

In addition, when insert molding is performed, the accuracy of the shapes of the plurality of friction materials 7 can be enhanced. Therefore, it is possible to suppress variations in height among the plurality of friction materials 7. Furthermore, the accuracy of the position where the plurality of friction materials 7 is provided can be enhanced. Therefore, the defect rate of the ultrasonic motor 1 can be reduced. Therefore, productivity can be effectively improved.

As illustrated in FIG. 3, the plurality of friction materials 7 are dispersedly arranged in the annular track A. As illustrated in FIG. 6, it is preferable that each friction material 7 is disposed such that the center of gravity G of each friction material 7 is located on the annular track A. As a result, the ultrasonic motor 1 can be more reliably and stably rotationally driven. Any portion of the friction material 7 may be located on the annular track A, and the center of gravity G of the friction material 7 may not necessarily be located on the annular track A.

As shown in FIG. 6, in the present embodiment, the shape of the through hole 6c of the leaf spring portion 6 in plan view is elliptical. As described above, the shape of the through hole 6c in plan view is preferably a shape having a length direction. Accordingly, it is difficult for the friction material 7 to rotate. However, when each friction material 7 is provided over the first surface 6a, the insides of the plurality of through holes 6c, and the second surface 6b of the leaf spring portion 6 as in the present embodiment, it is difficult for the friction material 7 to rotate regardless of the shape of the through hole 6c in plan view.

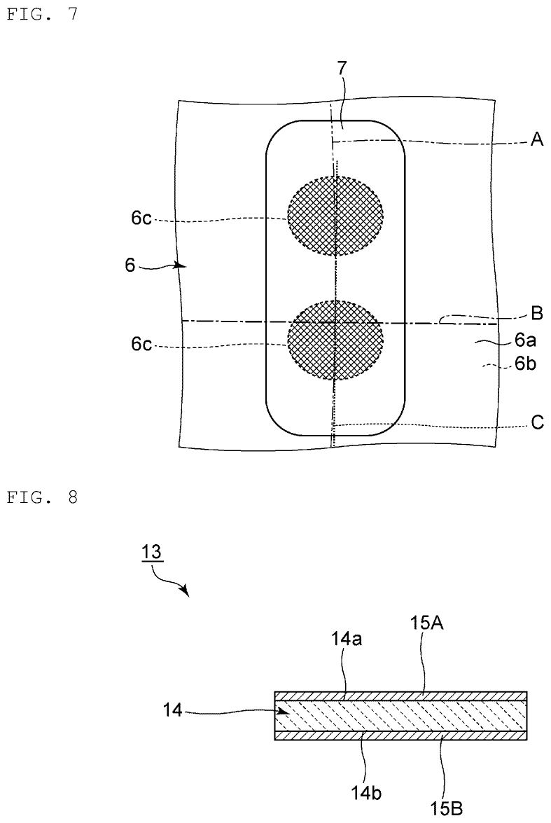

As illustrated in FIG. 7, it is preferable that the shape of the through hole 6c of the leaf spring portion 6 in plan view is configured by a line other than the line parallel to the annular track A. More specifically, the following relationship is preferably established in plan view. First, a virtual line B illustrated in FIG. 7 is an example of a straight virtual line passing through the through hole 6c from the center of the annular track A. The portion of the outer peripheral edge of the through hole 6c intersecting the virtual line B is preferably a part of a line other than a straight line parallel to a tangential line C of the portion intersecting the virtual line B in the annular track A. Although an infinite number of virtual lines B can be drawn from the center of the annular track A, the above relationship is preferably established in any portion of the outer peripheral edge of the through hole 6c. In the present embodiment, since the shape of the through hole 6c in plan view is elliptical, the above relationship is established in any portion of the outer peripheral edge of the through hole 6c.

In this case, when the ultrasonic motor 1 is rotationally driven, local concentration of the stress applied to the leaf spring portion 6 from the portion provided in the inside of the through hole 6c of the friction material 7 hardly occurs. That is, the stress applied to the leaf spring portion 6 from the portion provided in the inside of the through hole 6c of the friction material 7 can be alleviated. Therefore, the leaf spring portion 6 is less likely to be distorted. Therefore, the ultrasonic motor 1 can be more reliably and stably rotationally driven.

In the present embodiment, the area in plan view of the two through holes 6c formed in the portion of the leaf spring portion 6 where one friction material 7 is provided is in the following preferable range.

The area of the through hole 6c in plan view is preferably 0.3 mm² or more. When the plurality of through holes 6c are provided as in the present embodiment, the area of each through hole 6c is preferably 0.3 mm² or more. In this case, when the friction material 7 is formed, the resin for the friction material 7 easily passes through the through hole 6c of the leaf spring portion 6. Therefore, the friction material 7 can be easily formed, and the accuracy of the shape of the friction material 7 can be more reliably increased.

The total area of the through holes 6c provided in the leaf spring portion 6 in plan view is preferably 70% or less of the area of the friction material 7 in plan view. In other words, the total of the area of all the through holes 6c in plan view is preferably 70% or less of the area of the friction material 7 in plan view. In this case, it is easy to set the spring constant of the leaf spring portion 6 to a sufficient value in the portion where the friction material 7 is formed. In addition, the joint area between the friction material 7 and the leaf spring portion 6 can be increased. Therefore, the bonding force between the friction material 7 and the leaf spring portion 6 can be increased.

Here, as illustrated in FIG. 5, a maximum dimension, along an annular track or a track similar to the track, of a portion of the leaf spring portion 6 where one friction material 7 is provided is defined as L1. Note that, here, both ends of the portion of the leaf spring portion 6 where one friction material 7 is provided on an annular track or a track similar to the track are portions of the leaf spring portion 6 sandwiched by the friction material 7. On the other hand, a maximum dimension, along an annular track or a track similar to the track, of one through hole 6c in a portion where one friction material 7 is provided is defined as L2. In each through hole 6c, (L2/L1)×100<84 [%] is preferably satisfied, and (L2/L1)×100 ≤70 [%] is more preferably satisfied. In this case, it is also easy to set the spring constant of the leaf spring portion 6 to a sufficient value in the portion where the friction material 7 is formed. In addition, the joint area between the friction material 7 and the leaf spring portion 6 can be increased. Therefore, the bonding force between the friction material 7 and the leaf spring portion 6 can be increased.

Note that, in the present specification, the center of gravity of a shape having an outer shape of an annular track and the center of gravity of a shape having an outer shape of a track similar to the track are common. In the present embodiment, a shape having an annular track as an outer shape and a shape having a track similar to the track as an outer shape are concentric circles.

In the present embodiment, the dimension L1 is a dimension along the annular track of the portion of the leaf spring portion 6 where one friction material 7 is provided. However, when the dimension along the track similar to the annular track of the portion is larger than the dimension along the annular track of the portion, the dimension L1 is a dimension along the track similar to the annular track.

In FIG. 5, the dimension L1 and the dimension L2 are schematically illustrated on one surface, but in the present embodiment, strictly, the dimension L2 is a dimension along a track similar to an annular track of one through hole 6c in a portion where one friction material 7 is provided. Specifically, the dimension L2 is a dimension along an annular track having a slightly larger radius than the annular track A illustrated in FIG. 6.

The dimension L1 and the dimension L2 correspond to the length of the curve. Therefore, the dimension L1 and the dimension L2 may be calculated as annular tracks or lengths of curves of parts of tracks similar to the tracks. For example, when the annular track is an annular track as in the present embodiment, the dimension L1 and the dimension L2 may be calculated as lengths of arcs using the arc degree method.

Hereinafter, further details of the configuration of the present embodiment will be described.

As illustrated in FIG. 1, the ultrasonic motor 1 includes a first case member 8 and a second case member 9. The second case member 9 has a cap shape, and the first case member 8 has a lid shape. The first case member 8 and the second case member 9 constitute a case. The spring member 16, the rotor 4, and the stator 2 are disposed inside the case.

The first case member 8 has a first cylindrical protrusion 8a and a second cylindrical protrusion 8b. The first cylindrical protrusion 8a protrudes to the outside of the case. The second cylindrical protrusion 8b protrudes to the inside of the case. A part of the second cylindrical protrusion 8b is located in the through hole 3c of the vibrating body 3 of the stator 2.

The first cylindrical protrusion 8a and the second cylindrical protrusion 8b are continuously provided with a through hole 8c. A first bearing portion 18 is provided in a portion of the through hole 8c located at the first cylindrical protrusion 8a. The shaft member 10 is inserted through the through hole 8c and the first bearing portion 18. The shaft member 10 protrudes from the through hole 8c of the first case member 8 to the outside of the case. Note that the configuration of the first case member 8 is not limited to the above.

The second case member 9 has a cylindrical protrusion 9a. The cylindrical protrusion 9a protrudes to the outside of the case. The cylindrical protrusion 9a is provided with a through hole 9c. A second bearing portion 19 is provided in the through hole 9c. The shaft member 10 is inserted through the through hole 9c and the second bearing portion 19. The shaft member 10 protrudes from the through hole 9c of the second case member 9 to the outside of the case. Note that the configuration of the second case member 9 is not limited to the above. For example, a sliding bearing or a bearing may be used for the first bearing portion 18 and the second bearing portion 19.

As illustrated in FIG. 1, the plurality of friction materials 7 of the rotor 4 are in contact with the second main surface 3b of the vibrating body 3 in the stator 2. The second main surface 3b includes a contact surface 3d. The contact surface 3d is a portion of the second main surface 3b in contact with the rotor 4. The contact surface 3d has a planar shape. More specifically, the contact surface 3d is not provided with an uneven structure. The contact surface 3d is configured similarly to a portion of the second main surface 3b other than the contact surface 3d. Therefore, when the stator 2 of the present embodiment is obtained, it is not necessary to cut the second main surface 3b of the vibrating body 3. Therefore, as described above, the productivity of the ultrasonic motor 1 can be enhanced.

An elastic member 12 is provided on the rotor base portion 5 of the rotor 4. More specifically, the elastic member 12 sandwiches the rotor 4 together with the stator 2 in the axial direction Z. The elastic member 12 has an annular shape. Note that the shape of the elastic member 12 is not limited to the above. As a material of the elastic member 12, for example, rubber or resin can be used. However, the elastic member 12 may not be provided.

The spring member 16 is disposed on the second bearing portion 19 side of the elastic member 12. Specifically, the spring member 16 of the present embodiment is a leaf spring including metal. A through hole 16c is provided in a central portion of the spring member 16. The shaft member 10 is inserted through the through hole 16c. The shaft member 10 has a wide portion 10a. The width of the wide portion 10a of the shaft member 10 is wider than the width of the other portion of the shaft member 10. Note that the width of the shaft member 10 is a dimension along a direction orthogonal to the axial direction Z of the shaft member 10. An inner peripheral end edge portion of the spring member 16 is in contact with the wide portion 10a. As a result, the positional displacement between the spring member 16 and the shaft member 10 can be suppressed. However, the material and configuration of the spring member 16 are not limited to the above. The configuration of the shaft member 10 is also not limited to the above.

An elastic force is applied from the spring member 16 to the rotor 4 via the elastic member 12. As a result, the rotor 4 is pressed against the stator 2. In this case, frictional force between the stator 2 and the rotor 4 can be increased. Thus, the traveling wave can be effectively propagated from the stator 2 to the rotor 4, and the rotor 4 can be efficiently rotated. Therefore, the ultrasonic motor 1 can be efficiently rotationally driven.

As shown in FIG. 1, the shaft member 10 is provided with a snap ring 17. The snap ring 17 has an annular shape. In plan view, the snap ring 17 surrounds the shaft member 10. More specifically, an inner peripheral end edge portion of the snap ring 17 is located in the shaft member 10. The snap ring 17 is in contact with the first bearing portion 18 from the outside in the axial direction Z. As a result, the length between the snap ring 17 and the wide portion 10a of the shaft member 10 is defined, and the deflection amount of the spring member 16 is determined. As a result, as described above, the elastic force by the spring member 16 can be applied to the rotor 4. As material of the shaft member 10 and the snap ring 17, for example, metal or resin can be used.

As described above, the stator 2 includes the plurality of piezoelectric elements 13. Hereinafter, a specific configuration of the piezoelectric element 13 will be described.

FIG. 8 is a front sectional view of the piezoelectric element according to the first embodiment.

The piezoelectric element 13 includes a piezoelectric body 14. The piezoelectric body 14 has a third main surface 14a and a fourth main surface 14b. The third main surface 14a and the fourth main surface 14b face each other. The piezoelectric element 13 includes a first electrode 15A and a second electrode 15B. The first electrode 15A is provided at the third main surface 14a of the piezoelectric body 14, and the second electrode 15B is provided at the fourth main surface 14b. The shape of the piezoelectric element 13 in plan view is rectangular. The shape of the piezoelectric element 13 in plan view is not limited to the above, and may be, for example, an elliptical shape.

Alternatively, the stator 2 may include one piezoelectric element divided into a plurality of regions. In this case, for example, the regions of the piezoelectric element may be polarized in different directions from each other. The shape of the piezoelectric element in plan view is, for example, an annular shape.

Here, the first electrode 15A illustrated in FIG. 8 is attached to the first main surface 3a of the vibrating body 3 with an adhesive. The thickness of this adhesive is very thin. Therefore, the first electrode 15A is electrically connected to the vibrating body 3.

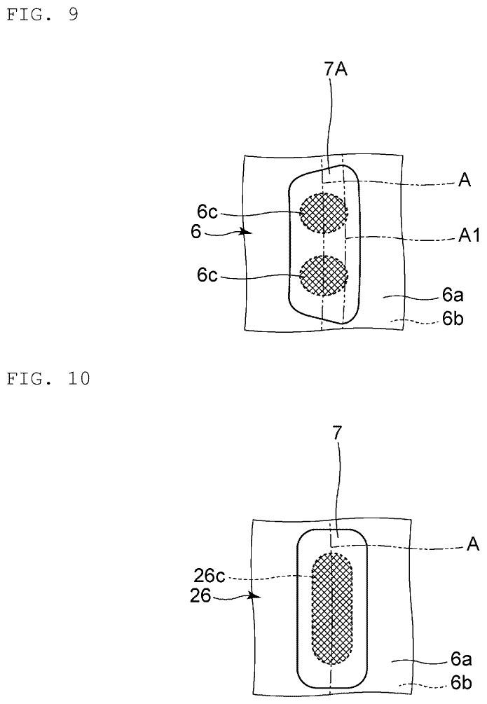

As shown in FIG. 6, in the first embodiment, the shape of the friction material 7 in plan view is rectangular. However, for example, the shape of the friction material 7 in plan view may be a shape corresponding to the annular track A. In the modification of the first embodiment illustrated in FIG. 9, the shape of each friction material 7A in plan view is a substantially fan shape. Specifically, the shape of the friction material 7A in plan view is a shape in which the center coincides with the annular track A, and a concentric arc having a smaller radius than the annular track A and a concentric arc having a larger radius are connected. Portions corresponding to the four vertexes in the shape are curved. A portion corresponding to the concentric arc having a smaller radius is located closer to the center side of the rotor than a portion corresponding to the concentric arc having a larger radius. A length of the portion corresponding to the concentric arc having a smaller radius is shorter than a length of the portion corresponding to the concentric arc having a larger radius.

Also in the present modification, similarly to the first embodiment, the plurality of friction materials 7 in the rotor is dispersedly arranged in an annular track in plan view. Therefore, productivity of the ultrasonic motor can be enhanced. Similarly to the first embodiment, the leaf spring portion 6 and the plurality of friction materials 7A of the present modification are an insert molded body integrally formed. Therefore, peeling of the friction material 7A hardly occurs, and the accuracy of the shape and the accuracy of the position of the friction material 7A can be more reliably enhanced.

In the present modification, the dimension L1 of the friction material 7A is a dimension along a track Al similar to the annular track A of the portion of the leaf spring portion 6 where one friction material 7A is provided.

Hereinafter, a second embodiment, a third embodiment, and modifications in which the shape of the through hole in the leaf spring portion of the rotor is different from that of the first embodiment will be described. Note that the second embodiment, the third embodiment, and the modifications are also different from the first embodiment in that there is only one through hole formed in a portion where one friction material is provided. Other than the points described above, the ultrasonic motors of the second modification and the third embodiments and the modifications are configured similarly to the ultrasonic motor 1 of the first embodiment. Also in the second embodiment, the third embodiment, and the modifications, similarly to the first embodiment, peeling of the friction material hardly occurs, the accuracy of the shape and the accuracy of the position of the friction material can be more reliably increased, and the productivity of the ultrasonic motor can be enhanced.

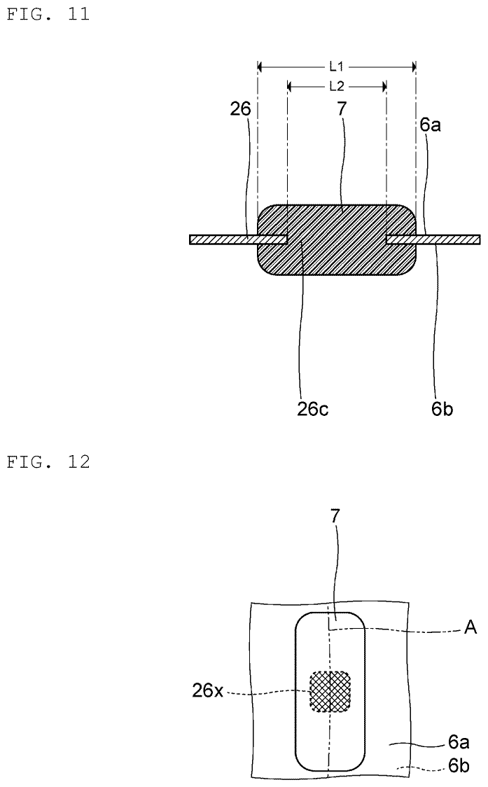

FIG. 10 is a schematic plan view illustrating the vicinity of a portion where one friction material is provided on the first surface of the leaf spring portion of the rotor in the second embodiment. FIG. 11 is a schematic sectional view along an annular track showing the vicinity of a portion where one friction material is provided in the leaf spring portion of the rotor in the second embodiment.

As illustrated in FIG. 10, in the present embodiment, a through hole 26c of a leaf spring portion 26 has an oval shape in plan view. As illustrated in FIG. 11, when only one through hole 26c is provided in the portion where one friction material 7 is provided, it is easy to increase the dimension L2 of the through hole 26c. Accordingly, when the friction material 7 is formed, the resin for the friction material 7 easily passes through the through hole 26c of the leaf spring portion 26. Therefore, the friction material 7 can be easily formed, and the accuracy of the shape of the friction material 7 can be more reliably increased.

As described above, the shape of the through hole 26c in plan view is an oval shape. Therefore, the shape is a shape having a length direction. Accordingly, when only one through hole 26c is provided in the portion where one friction material 7 is provided, the friction material 7 is less likely to rotate.

The shape of the through hole 26c in plan view may be, for example, an ellipse, a polygon, or the like. In a modification of the second embodiment shown in FIG. 12, a shape of a through hole 26x in plan view is a square. More specifically, a portion corresponding to a vertex of the square has a curved shape. The shape of the through hole 26x in plan view is a shape having no length direction. However, the shape of the through hole 26x is not the shape of the rotating body. Also in this case, similarly to the second embodiment, when only one through hole 26x is provided in the leaf spring portion, the friction material 7 is less likely to rotate.

As in the present modification, when the shape of the through hole 26x provided in the leaf spring portion in plan view is a regular polygon or a polygon having a length direction, the shape of the through hole in plan view is preferably a shape in which a portion corresponding to a vertex of the polygon is curved. Accordingly, the friction material 7 can be more reliably filled in all the portions in the through hole 26x. As a result, the bonding force between the leaf spring portion and the friction material 7 can be more reliably increased.

Alternatively, the shape of the through hole in plan view may be a shape in which portions corresponding to a plurality of vertices are connected by a curve and portions corresponding to a plurality of vertices are curved. In this case, similarly to the first embodiment, when a straight line passing through the through hole is drawn from the center of the annular track in plan view, a portion intersecting the virtual line at the outer peripheral edge of the through hole is a part of a line other than the straight line parallel to the tangential line of the portion intersecting the virtual line in the annular track. As a result, when the ultrasonic motor is rotationally driven, local concentration of the stress applied to the leaf spring portion from the portion provided in the through hole of the friction material hardly occurs.

The leaf spring portion may be provided with a plurality of through holes having the shape in the example described herein. Similarly, the leaf spring portion may be provided with a plurality of through holes having the shape of the second embodiment or the modification thereof. The friction material may be provided over the first surface, insides of the plurality of through holes, and the second surface of the leaf spring portion.

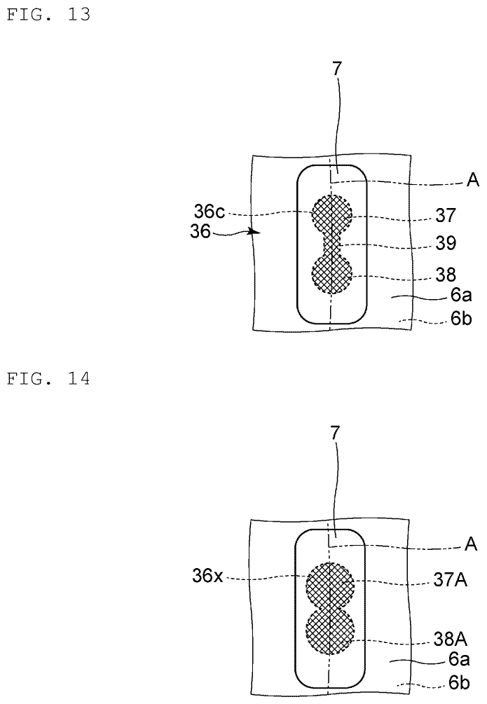

FIG. 13 is a schematic plan view illustrating the vicinity of a portion where one friction material is provided on the first surface of the leaf spring portion of the rotor in the third embodiment.

In the present embodiment, a through hole 36c of a leaf spring portion 36 has a gourd-like shape in plan view. Specifically, the through hole 36c includes a first portion 37, a second portion 38, and a coupling portion 39. The shapes of the first portion 37 and the second portion 38 in plan view are circular. The shape of the coupling portion 39 in plan view is rectangular. The first portion 37 and the second portion 38 are connected by the coupling portion 39. That is, in the present embodiment, the coupling portion 39 is a portion to which the first portion 37 and the second portion 38 are connected. The maximum dimension, along the direction of the normal line of the annular track A, of the coupling portion 39 is smaller than the maximum dimension of each of the first portion 37 and the second portion 38 along the direction of the normal line of the annular track A.

As a result, the joint area between the friction material 7 and the leaf spring portion 36 can be increased. Therefore, the bonding force between the friction material 7 and the leaf spring portion 36 can be increased. Furthermore, it is easy to set the spring constant of the leaf spring portion 6 to a sufficient value. Accordingly, the friction material 7 can be suitably pressed against the stator. Therefore, frictional force between the stator and the rotor can be increased. Therefore, the ultrasonic motor can be efficiently rotationally driven.

On the other hand, the maximum dimension, along the direction of the normal line of the annular track A, of each of the first portion 37 and the second portion 38 is larger than the maximum dimension, along the direction of the normal line of the annular track A, of the coupling portion 39. Furthermore, only one through hole 36c is provided in the portion where one friction material 7 is provided. Therefore, it is easy to increase the dimension L2 of the through hole 36c. Therefore, when the friction material 7 is formed, the resin for the friction material 7 easily passes through the through hole 36c of the leaf spring portion 36. Therefore, the friction material 7 can be easily formed, and the accuracy of the shape of the friction material 7 can be more reliably increased.

Note that the shape of the first portion 37 in plan view is not limited to a circular shape. For example, the shape may be an ellipse, a triangle, a polygon, or the like. The same applies to the second portion 38. The shape of the coupling portion 39 in plan view is not limited to a rectangle. For example, a shape in which the dimension along the direction of the normal line of the annular track A in the central portion is narrowed, such as an hourglass shape, may be used.

In the through hole 36c in the third embodiment, the first portion 37 and the second portion 38 are indirectly connected by the coupling portion 39. However, the present description is not limited thereto. For example, in the modification of the third embodiment shown in FIG. 14, a through hole 36x provided in the leaf spring does not have a coupling portion. In the through hole 36x, the first portion 37A and the second portion 38A are directly connected. In the present modification, a boundary between the first portion 37 and the second portion 38 is a portion to which the first portion 37A and the second portion 38A are connected. The shape of the through hole 36x in plan view is a gourd-like shape without a coupling portion.

The dimension along the direction of the normal line of the annular track A of the portion to which the first portion 37A and the second portion 38A are connected is assumed to be a dimension along the direction of the normal line of the annular track A of the portion including the boundary between the first portion 37A and the second portion 38A. In the present modification, the maximum dimension, along the direction of the normal line of the annular track A, of the portion to which the first portion 37A and the second portion 38A are connected is smaller than the maximum dimension, along the direction of the normal line of the annular track A, of each of the first portion 37A and the second portion 38A.

Also in the present modification, similarly to the third embodiment, the joint force between the friction material 7 and the leaf spring portion can be increased. Furthermore, it is easy to set the spring constant of the leaf spring portion to a sufficient value. In addition, when the friction material 7 is formed, the resin for the friction material 7 easily passes through the through hole 36c of the leaf spring portion 36. Therefore, the friction material 7 can be easily formed, and the accuracy of the shape of the friction material 7 can be more reliably increased.

Note that the leaf spring portion may be provided with a plurality of through holes having the shape of the third embodiment or the modification thereof. The friction material may be provided over the first surface, insides of the plurality of through holes, and the second surface of the leaf spring portion.

Hereinafter, embodiments of a rotor and an ultrasonic motor according to the present description will be collectively described.

<1> A rotor used in an ultrasonic motor that includes a stator, the stator including a vibrating body and a vibration generating element provided on the vibrating body, the rotor including: a rotor main body; and a plurality of friction materials provided in the rotor main body and in contact with the vibrating body, in which the plurality of friction materials includes resin, and in which the plurality of friction materials is dispersedly arranged in an annular track in plan view.

<2> The rotor according to <1>, in which the rotor main body includes a rotor base portion having a recessed portion, and a leaf spring portion provided on the rotor base portion so as to cover the recessed portion, in which the leaf spring portion includes a first surface and a second surface facing each other, and a plurality of through holes are provided from the first surface to the second surface, and in which each of the friction materials is provided over the first surface, an inside of the through hole, and the second surface of the leaf spring portion.

<3> The rotor according to <2>, in which each of the friction materials is provided over the first surface, an inside of only one of the through holes, and the second surface of the leaf spring portion.

<4> The rotor according to <2>, in which each of the friction materials is provided over the first surface, insides of the plurality of through holes, and the second surface of the leaf spring portion.

<5> The rotor according to any one of <2> to <4>, in which a portion of an outer peripheral edge of the through hole intersecting a straight virtual line passing through the through hole from a center of the annular track in plan view is a part of a line other than a straight line parallel to a tangential line of a portion intersecting the virtual line in the annular track.

<6> The rotor according to any one of <2> to <4>, in which a shape of the through hole in plan view is a shape having a length direction.

<7> The rotor according to any one of <2> to <4>, in which a shape of the through hole in plan view is an elliptical shape or an oval shape.

<8> The rotor according to any one of <2> to <4>, in which a shape of the through hole in plan view is a shape in which a shape of a portion corresponding to a vertex of a polygon is curved.

<9> The rotor according to any one of <2> to <4>, in which the through hole has a first portion and a second portion, and the first portion and the second portion are connected to each other, and in which a maximum dimension, along a direction of a normal line of the annular track, of a portion to which the first portion and the second portion are connected is smaller than a maximum dimension, along the direction of the normal line of the annular track, of each of the first portion and the second portion.

<10> The rotor according to any one of <2> to <9>, in which an area of one of the through holes in plan view in a portion of the leaf spring portion where one of the friction materials is provided is 0.3 mm² or more.

<11> The rotor according to any one of <2> to <10>, in which a total area of the through hole in plan view in a portion of the leaf spring portion where one of the friction materials is provided is 70% or less of an area of the friction material in plan view.

<12> The rotor according to any one of <2> to <11>, in which the leaf spring portion and the plurality of friction materials are an insert molded body integrally formed.

<13> An ultrasonic motor including: the rotor according to any one of <1> to <12>; and the stator including the vibrating body and the vibration generating element provided on the vibrating body, in which the vibrating body includes a contact surface in contact with the plurality of friction materials, and in which the contact surface has a planar shape.

### DESCRIPTION OF REFERENCE SYMBOLS

1: Ultrasonic motor
2: Stator
3: Vibrating body
3a, 3b: First and second main surfaces
3c: Through hole
3d: Contact surface
4: Rotor
4A: Rotor main body
4c: Through hole
5: Rotor base portion
5a: Recessed portion
5b, 5c: Groove portion
6: Leaf spring portion
6a, 6b: First and second surfaces
6c: Through hole
7, 7A: Friction material
8: First case member
8a, 8b: First and second cylindrical protrusions
8c: Through hole
9: Second case member
9a: Cylindrical protrusion
9c: Through hole
10: Shaft member
10a: Wide portion
12: Elastic member
13: Piezoelectric element
14: Piezoelectric body
14a, 14b: Third and fourth main surfaces
15A, 15B: First and second electrodes
16: Spring member
16c: Through hole
17: Snap ring
18, 19: First and second bearing portions
26, 36: Leaf spring portion
26c, 26x, 36c, 36x: Through hole
37, 38: First and second portions
37A, 38A: First and second portions
39: Coupling portion
A: Annular track
A1: Track
B: Virtual line
C: Tangential line

1. A rotor used in an ultrasonic motor, the rotor comprising:
a rotor main body; and
a plurality of friction materials in the rotor main body and arranged for contact with a vibrating body of a stator,
wherein the plurality of friction materials include resin, and
wherein the plurality of friction materials are dispersedly arranged in an annular track in a plan view of the rotor.

2. The rotor according to claim 1,
wherein the rotor main body includes a rotor base portion having a recessed portion, and a leaf spring portion on the rotor base portion and positioned so as to cover the recessed portion,
wherein the leaf spring portion includes a first surface and a second surface facing each other, and a plurality of through holes extending from the first surface to the second surface, and
wherein each of the plurality of friction materials is provided over the first surface, an inside of at least one of the plurality of through holes, and over the second surface of the leaf spring portion.

3. The rotor according to claim 2, wherein each of the friction materials is provided over the first surface, an inside of a plurality of the plurality of through holes, and over the second surface of the leaf spring portion.

4. The rotor according to claim 2, wherein each of the friction materials is provided over the first surface, insides two through holes of the plurality of through holes, and over the second surface of the leaf spring portion.

5. The rotor according to claim 2, wherein a portion of an outer peripheral edge of each of the through holes intersecting a straight virtual line passing through the at least one of the through holes from a center of the annular track in the plan view is a part of a line other than a straight line parallel to a tangential line of a portion intersecting the straight virtual line.

6. The rotor according to claim 2, wherein a shape of each of the plurality of through holes in the plan view is a shape having a length direction larger than a width direction thereof.

7. The rotor according to claim 2, wherein a shape of each of the plurality of through holes in the plan view is an elliptical shape or an oval shape.

8. The rotor according to claim 2, wherein a shape of each of the plurality of through holes in the plan view is a polygon and wherein a portion corresponding to a vertex of the polygon is curved.

9. The rotor according to claim 2,
wherein each of the plurality of through holes has a first portion and a second portion, and the first portion and the second portion are connected to each other, and
wherein a first maximum dimension along a direction of a normal line of the annular track of a portion connecting the first portion and the second portion is smaller than a second maximum dimension along the direction of the normal line of the annular track of each of the first portion and the second portion.

10. The rotor according to claim 2, wherein an area of the at least one of the plurality of through holes in the plan view is 0.3 mm² or more.

11. The rotor according to claim 2, wherein a total area of the plurality of through holes in the plan view is 70% or less of an area of the plurality of friction materials in the plan view.

12. The rotor according to claim 2, wherein the leaf spring portion and the plurality of friction materials are an integral body.

13. An ultrasonic motor comprising:
the rotor according to claim 1; and
a stator including the vibrating body and a vibration generating element on the vibrating body,
wherein the vibrating body includes a contact surface in contact with the plurality of friction materials, and
wherein the contact surface has a planar shape.

14. The ultrasonic motor according to claim 13,
wherein the rotor main body includes a rotor base portion having a recessed portion, and a leaf spring portion on the rotor base portion and positioned so as to cover the recessed portion,
wherein the leaf spring portion includes a first surface and a second surface facing each other, and a plurality of through holes extending from the first surface to the second surface, and
wherein each of the plurality of friction materials is provided over the first surface, an inside of at least one of the plurality of through holes, and over the second surface of the leaf spring portion.

15. The rotor according to claim 14, wherein each of the friction materials is provided over the first surface, an inside of a plurality of the plurality of through holes, and over the second surface of the leaf spring portion.

16. The rotor according to claim 14, wherein a shape of each of the plurality of through holes in the plan view is a shape having a length direction larger than a width direction thereof.

17. The rotor according to claim 14, wherein a shape of each of the plurality of through holes in the plan view is an elliptical shape or an oval shape.

18. The rotor according to claim 14, wherein a shape of each of the plurality of through holes in the plan view is a polygon and wherein a portion corresponding to a vertex of the polygon is curved.

19. The rotor according to claim 14,
wherein each of the plurality of through holes has a first portion and a second portion, and the first portion and the second portion are connected to each other, and
wherein a first maximum dimension along a direction of a normal line of the annular track of a portion connecting the first portion and the second portion is smaller than a second maximum dimension along the direction of the normal line of the annular track of each of the first portion and the second portion.

20. The rotor according to claim 14, wherein a total area of the plurality of through holes in the plan view is 70% or less of an area of the plurality of friction materials in the plan view.
